(19) United States
(12) Patent Application Publication
(10) Pub. No.: US 2017/0185426 A1
(43) Pub. Date: Jun. 29, 2017

(54) REUSE SUPPORT SYSTEM AND METHOD

(71) Applicant: Tokyo Electric Power Company Holdings, Incorporated, Tokyo (JP)

(72) Inventors: Noboru KOBAYASHI, Tokyo (JP); Tamotsu OGAWA, Tokyo (JP); Chikara MOROOKA, Tokyo (JP); Yuki MATSUOKA, Tokyo (JP)

(73) Assignee: Tokyo Electric Power Company Holdings, Incorporated, Tokyo (JP)

(21) Appl. No.: 15/460,585

(22) Filed: Mar. 16, 2017

Related U.S. Application Data
(63) Continuation-in-part of application No. PCT/JP2014/081747, filed on Dec. 1, 2014.

(51) Int. Cl. G06F 9/44; G06F 3/0482

(52) U.S. Cl. CPC G06F 9/4446; G06F 3/0482

(57) ABSTRACT

A reuse support system of an embodiment includes a display controller which displays, on a display, an image including an image of a boundary sample which serves as a reference for reuse of a facility in response to operation of a worker, an acceptor which accepts selection of a reuse mode of the facility, and a manager which manages a delivery destination of the facility based at least in part on the reuse mode of the facility selected by the acceptor.

### BACKGROUND

Technical Field

Embodiments of the present invention generally relate to a reuse support system and a reuse support method.

Related Art

A facility laid on or buried under a road or the like may be reused without replacement with a new item depending on a state of the facility. A worker of an electric power company or the like may judge a reuse mode of the facility based at least in part on a state of the facility, for example, referring to Japanese Unexamined Patent Application Publication JP 2014-6191 A.

To judge a reuse mode of a facility, skills are required. There have been cases where a worker cannot judge the reuse mode of the facility in an appropriate and efficient manner.

### SUMMARY

A reuse support system may include, but is not limited to, a display controller which displays, on a display, an image including an image of a boundary sample which serves as a reference for reuse of a facility in response to operation of a worker, an acceptor which accepts selection of a reuse mode of the facility, and a manager which manages a delivery destination of the facility based at least in part on the reuse mode of the facility selected by the acceptor.

### BRIEF DESCRIPTION OF THE DRAWINGS

FIG. 1 is a diagram representing a configuration of a reuse support system of a first embodiment.

FIG. 2 is a diagram representing an exemplary image for inputting skill data of the first embodiment.

FIG. 3 is a diagram representing a data table including skill data of the first embodiment.

FIG. 4 is a diagram representing a data table including skill data and a work license of the first embodiment.

FIG. 5 is a diagram representing an exemplary image representing skill data or the first embodiment.

FIG. 6 is a diagram representing an image for authentication of a worker of the first embodiment.

FIG. 7 is a diagram representing a first example of an image including a boundary sample image of the first embodiment.

FIG. 8 is a diagram representing a second example of an image including a boundary sample image of the first embodiment.

FIG. 9 is a diagram representing a third example of an image including a boundary sample image of the first embodiment.

FIG. 10 is a diagram representing a fourth example of an image including a boundary sample image of the first embodiment.

FIG. 11 is a flowchart representing operations of a reuse support device of the first embodiment.

FIG. 12 is a flowchart representing operations of a reuse support terminal of the first embodiment.

FIG. 13 is a sequence diagram representing operations of the reuse support system of the first embodiment.

FIG. 14 is a diagram representing a data table, including information of a work license and a power facility a reuse mode of which is selectable, of a second embodiment.

FIG. 15 is a diagram representing a fourth example of an image including a boundary sample image of the second embodiment.

FIG. 16 is a diagram representing a fifth example of an image including a boundary sample image of the second embodiment.

FIG. 17 is a flowchart representing operations of a reuse support device of the second embodiment.

### DETAILED DESCRIPTION OF THE EMBODIMENTS

A reuse support system may include, but is not limited to, a display controller which displays, on a display, an image including an image of a boundary sample which serves as a reference for reuse of a facility in response to operation of a worker, an acceptor which accepts selection of a reuse mode of the facility, and a manager which manages a delivery destination of the facility based at least in part on the reuse mode of the facility selected by the acceptor.

In the reuse support system, the display controller displays, on the display, an image including an image for accepting selection of the reuse mode of the facility.

In the reuse support system, the acceptor accepts selection as to whether the facility is reusable as selection of the reuse mode of the facility.

En the reuse support system, the acceptor accepts selection whether to reuse with repair as selection of the reuse mode of the facility.

In the reuse support system, the acceptor accepts selection representing a judgement result of a level of the repair as selection of the reuse mode of the facility.

The reuse support system may further include, but is not limited to, a communicator which transmits, to the manager, information for specifying the delivery destination.

In the reuse support system, the facility is a power facility.

Some embodiments of the present invention may allow an acceptor to accept selection of the reuse mode of a power facility. As a result, the reuse support system allows a worker to judge the reuse mode of the facility in an appropriate and efficient manner.

The term “facility” used in embodiments refers to every tangible thing, which can in generally be designed, constructed, built, manufactured, installed, and maintained for performing any purpose, activities or functions in human society. In some cases, the facility may include, but is not limited to, a permanent, semi-permanent or temporary commercial or industrial property such as building, plant, or structure for performing any purpose, activities or functions in human society.

The term “event” used in embodiments refers to something that happens such as a social occasion or activity.

The term “equipment” used in embodiments refers to a set of one or more tangible articles or physical resources such as, but not limited to, some structural or tangible elements, apparatus, devices, or implements used in an operation or activity; fixed assets other than land and buildings.

The term “equipment/material” used in embodiments refers to at least one of equipment and material, for example, equipment alone, material alone or in combination.

Hereinafter, embodiments of a reuse support system and a reuse support terminal will be described in detail with reference to the drawings.

### First Embodiment

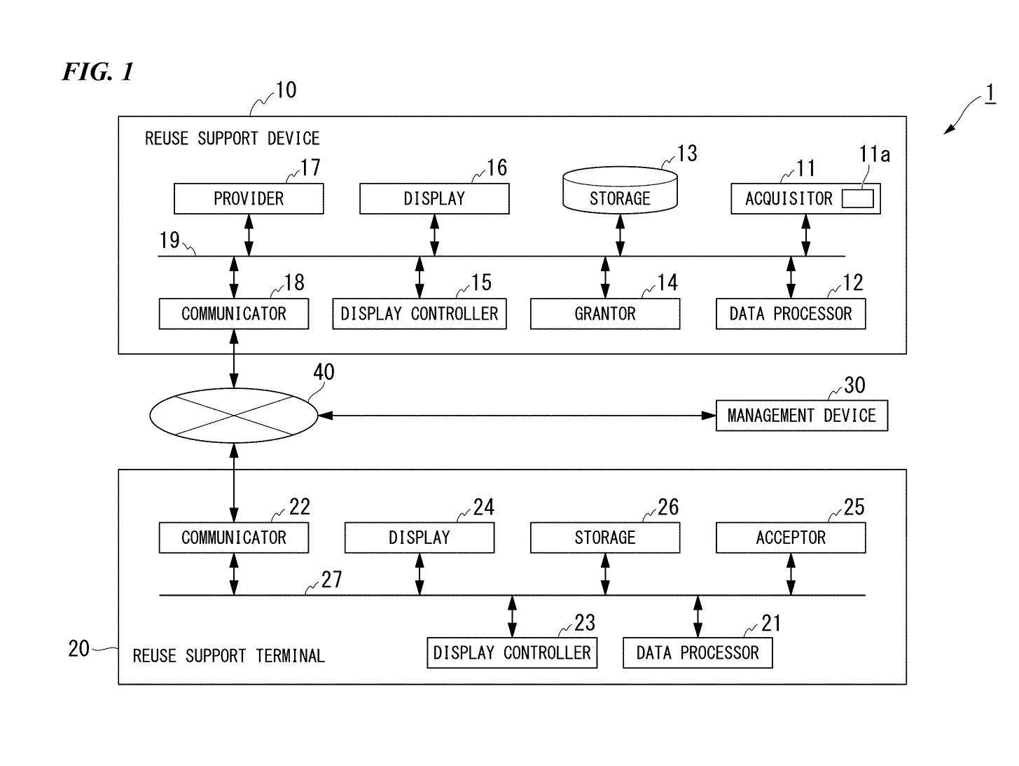

FIG. 1 is a diagram representing a configuration of a reuse support system 1. The reuse support system 1 includes a reuse support device 10 and a reuse support terminal 20. The reuse support system 1 may further include a management device 30. The reuse support device 10 and reuse support terminal 20 can communicate with each other via a communication line 40. Also, the reuse support terminal 20 and management device 30 can communicate with each other via the communication line 40.

A configuration of the reuse support device 10 will be described.

The reuse support device 10 provides an image for supporting judgement of a reuse mode of a facility to the reuse support terminal 20. This facility may be any facility and is not limited to a specific facility. The facility may be, for example, a production facility, repairing facility, gas facility, water supply facility, communication facility, or power facility. Hereinafter, the facility will be described as, for example, a power facility.

The reuse support device 10 is, for example, a server device. The reuse support device 10 provides an image of a boundary sample (hereinafter referred to as “boundary sample image”) to the reuse support terminal 20. The boundary sample image of a power facility is assumed as a reference for reuse of the power facility and used for judgement of a reuse mode of the power facility by a worker based at least in part on a state of the power facility.

The reuse mode of a power facility includes, for example, “good”, “minor repair”, “acceptable (major repair)”, and “useless”. The reuse mode of “good” is a mode where no repair is required and thus the power facility is reused without repair. The reuse mode of “minor repair” is a mode where the power facility is reused with simple repair (minor repair). This simple repair includes, for example, re-painting including rust removal.

The reuse mode of “acceptable” is a mode where the power facility is reused with repair which is not simple (major repair). This repair which is not simple includes, for example, replacement of a part. This repair which is not simple may be performed with the power facility by not only the worker of the power facility but also a technician specialized in power facility repair or a technician of a manufacturer of power facilities. The reuse mode of “useless” is a mode where the power facility is not reused and discarded.

The boundary sample image includes, for example, an image of the power facility corresponding to a threshold between a state judged as the reuse mode “good” and a state judged as the reuse mode “minor repair”. The boundary sample image includes, for example, an image of the power facility corresponding to a threshold between the state judged as the reuse mode “minor repair” and a state judged as the reuse mode “acceptable”. The boundary sample image includes, for example, an image of the power facility corresponding to a threshold between the state judged as the reuse mode “acceptable” and a state judged as the reuse mode “useless”. The boundary sample image includes, for example, an image of the power facility corresponding to the state judged as the reuse mode “useless”. The boundary sample image may also include letters or numbers representing a description for supporting judgement of the reuse mode.

The reuse support device 10 includes an acquisitor 11, a data processor 12, a storage 13, a grantor 14, a display controller 15, a display 16, a provider 17, a communicator 18, and a bus 19. The acquisitor 11, data processor 12, storage 13, grantor 14, display controller 15, display 16, provider 17, and communicator 18 can communicate with each other via the bus 19.

A part or all of the acquisitor 11, data processor 12, grantor 14, display controller 15, provider 17, and communicator 18 is a software function unit which functions by, for example, execution of a program stored in the storage 13 by a processor such as a central processing unit (CPU). Moreover, a part or all of these function units may be a hardware function unit such as a large scale integration (LSI) or an application specific integrated circuit (ASIC).

The acquisitor 11 includes an operator 11a. The operator 11a is an interface such as a keyboard, mouse, touch panel, or memory slot and is operated by a user of the reuse support device 10. The acquisitor 11 acquires skill data of the workers, worker numbers, names of the workers, comments, etc. input via the operator 11a.

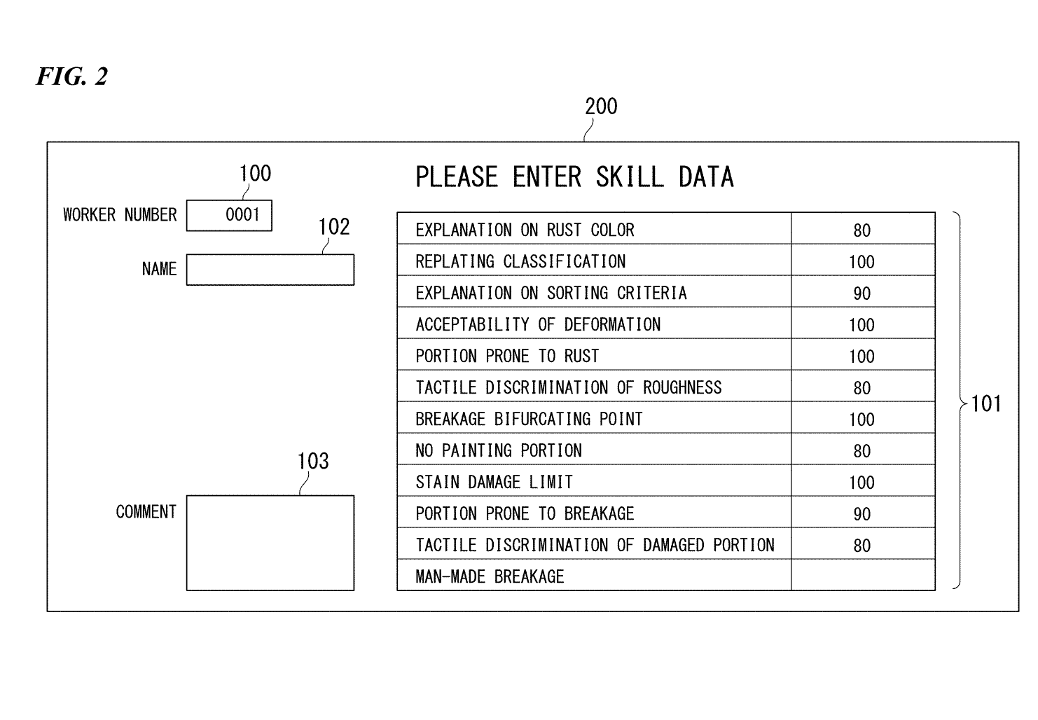

FIG. 2 is a diagram representing an exemplary image 200 for inputting skill data. The display 16 displays the image 200. The image 200 includes a worker number input area 100, a skill data input area 101, a name input area 102, and a comment input area 103. The worker number input area 100 is an area for inputting a worker number.

The skill data input area 101 is an area for inputting skill data for each item corresponding to a type of a power facility. In FIG. 2, items corresponding to a type of a power facility includes “explanation on rust color”, “replating classification”, “explanation on sorting criteria”, “acceptability of deformation”, “portion prone to rust”, “tactile discrimination of roughness”, “no breaking portion”, “no painting portion”, “stain damage limit”, “portion prone to breakage”, “tactile discrimination of damaged portion”, and “man-made breakage”.

The power facility may be any facility as long as the facility is related to power and is not limited to a specific facility. For example, the power facility includes an electrical wire, cable, pole transformer, high pressure switch, high voltage cut-out, low voltage lead-in fuse, lightning arrester, high voltage coupler, controller and the like, low voltage lead-in box, ground transformer, ground switching device, closed disconnector, copper bus bar, ground devices for underground wire, concrete column, high-tension insulator, low-tension insulator, protective tube for underground wire, metal hardware and the like, cover, etc. The skill data represents skills to judge the reuse mode of the power facility and is expressed, for example, by scores.

The name input area 102 is an area for inputting a name of a worker. The comment input area 103 is an area for inputting letters corresponding to a comment.

The data processor 12 calculates a score converted into from the skill data such that an upper limit is 100 points (hereinafter referred to as “converted score”) and registers the calculated converted score in a data table in the storage 13. The data processor 12 also generates an image of a radar chart representing the converted score for each item corresponding to the type of the power facility based at least in part on this data table and outputs the generated image to the display controller 15.

The storage 13 includes a nonvolatile storage medium (non-temporal storage medium) such as a read only memory (ROM), flash memory, or hard disk drive (HDD). The storage 13 may include a volatile storage medium such as a random access memory (RAM) or register. The storage 13 may store a program for causing the software function unit to operate. The storage 13 may store the skill data included in the data table.

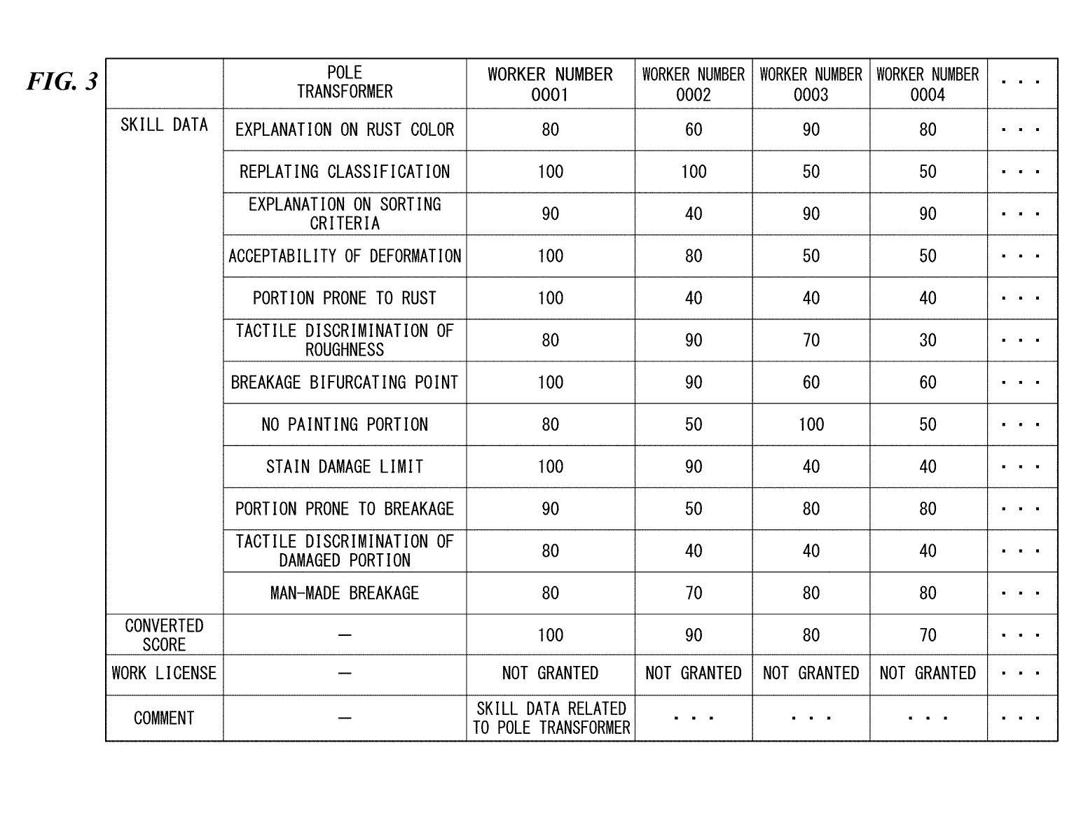

FIG. 3 is a diagram representing a data table including skill data. In the data table represented in FIG. 3, the skill data, converted score, work license, and comment, for each item defined for a pole transformer as the power facility, are associated with a worker number. This skill data is the data which has been input to the skill data input area 101 in the image 200. The items defined for the pole transformer includes, for example, an item related to a skill of explaining a rust color. Incidentally, in the data table represented in FIG. 3, the work license is not granted.

The grantor 14 grants the work license to the workers based at least in part on the skill data of the workers having been acquired by the acquisitor 11. The grantor 14 grants the work license to the workers in accordance with the converted score calculated by the data processor 12. For example, the grantor 14 grants the work license of a relatively high level as the converted score increases. Moreover, for example, the grantor 14 grants the work license where the reuse mode of the power facility cannot be selected when, of the items of the skill data, there is one or more items which does not satisfy a passing point. The grantor 14 stores the granted work license for each of the workers in the storage 13.

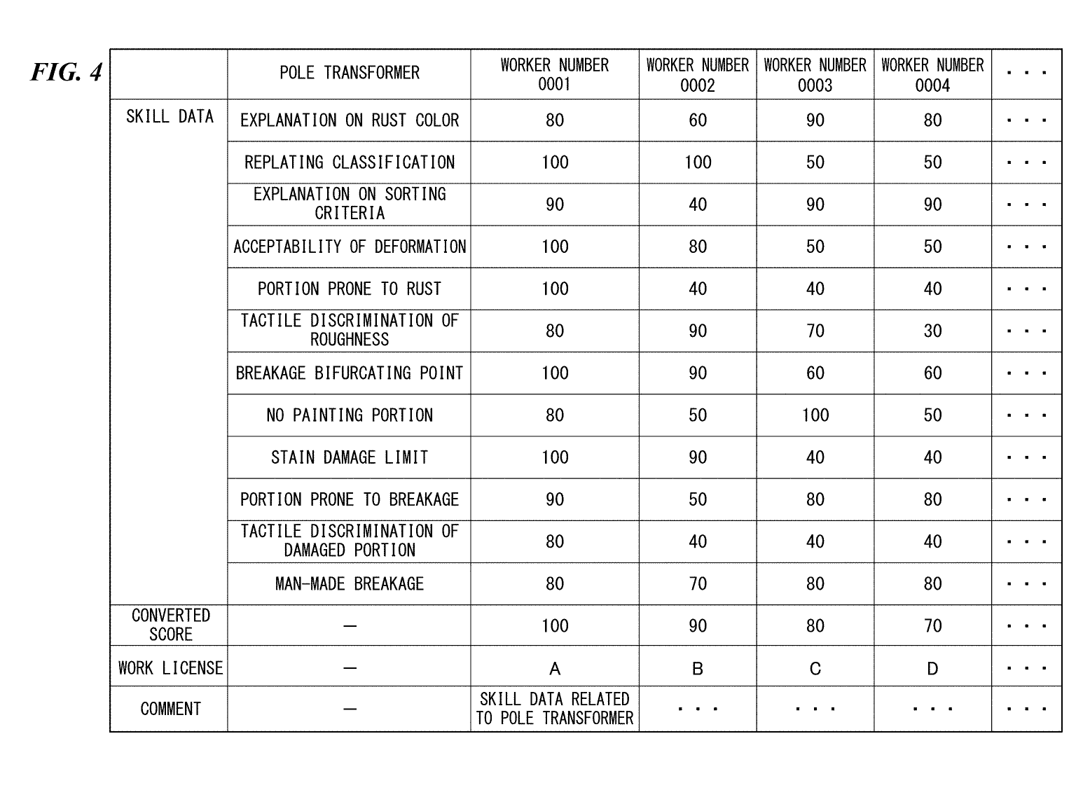

FIG. 4 is a diagram representing a data table including skill data and a work license. The work license is represented by, for example, one of work licenses A to D. Of the work licenses A to D, the work license A is on the highest level. Moreover, the level of the work license decreases in the order from the work license B to the work license C. Furthermore, the work license D is on the lowest level. The grantor 14 registers one of A to D to the item “work license” in the table data represented in FIG. 3 in accordance with the granted work license.

In the first embodiment, the worker can select the reuse mode of any of the predetermined power facility when granted with one of the work licenses A to C, namely, the work license C or above. Therefore, in FIG. 4, a worker with a worker number “0004” is granted with the work license D and thus cannot select the reuse mode of any of the power facility.

The display controller 15 displays an image on the display 16. This image may be, for example, generated by the data processor 12.

The display 16 displays the image on a display screen in response to control by the display controller 15. This image may, for example, represent the skill data. The display 16 may further include a touch panel. The display 16 outputs, to the acquisitor 11, a signal corresponding to operation of this touch panel.

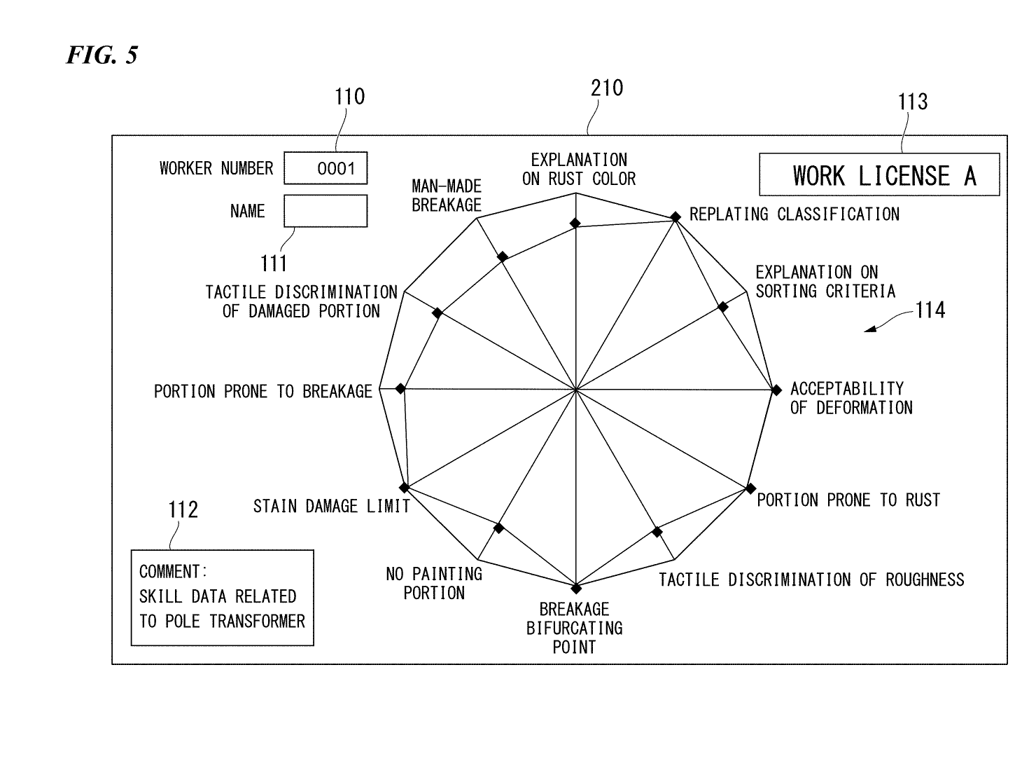

FIG. 5 is a diagram representing an exemplary image 210 representing skill data. The image 210 includes a worker number input area 110, a name input area 111, a comment input area 112, a work license display area 113, and a radar chart 114. The worker number input area 110 is an area for inputting a worker number. The name input area 111 is an area for inputting a name of a worker associated with the worker number. The work license display area 113 displays the work license granted to the worker. The radar chart 114 is an image of a radar chart representing the converted score for each item defined for the pole transformer as the power facility.

The provider 17 acquires authentication operation information from the reuse support terminal 20 via the communicator 18. The authentication operation information represents authentication operation by the worker operating the reuse support terminal 20. The provider 17 reads, from the data table stored in the storage 13, the work license associated with the worker number included in the acquired authentication operation information.

The provider 17 determines that selection of the reuse mode of the power facility can be accepted when the work license read from the storage 13 is one of A to C. The provider 17 provides, to the reuse support terminal 20, an image including both of a selection operation key image and boundary sample image when selection of the reuse mode of the power facility can be accepted.

The selection operation key image is an image of an operation key which enables accepting selection of the reuse mode of the power facility. The selection operation key image may be, for example, in the form of a pulldown menu. The worker can select the reuse mode of the power facility by operating the selection operation key image when the selection operation key image is displayed on the reuse support terminal 20.

The provider 17 determines that selection of the reuse mode of the power facility cannot be accepted when the work license read from the storage 13 is D. The provider 17 provides, to the reuse support terminal 20, an image not including the specific selection operation key image but including the boundary sample image when selection of the reuse mode of the power facility cannot be accepted. In this case, the worker cannot select the reuse mode of the power facility since the specific selection operation key image is not displayed on the reuse support terminal 20.

The communicator 18 communicates with the reuse support terminal 20 via the communication line 40. The communicator 18 transmits the image acquired from the provider 17 to the reuse support terminal 20. The image acquired from the provider 17 may include an image including letters representing one of the work licenses A to D. The communicator 18 transfers the authentication operation information received from the reuse support terminal 20 to the provider 17.

A configuration of the reuse support terminal 20 will be described.

The reuse support terminal 20 displays an image provided from the reuse support device 10. This provided image is an image for supporting judgement of the reuse mode of the power facility such as the boundary sample image. The reuse support terminal 20 is an information terminal such as a tablet, smartphone, or personal computer.

The reuse support terminal 20 includes an acceptor 25, a display controller 23, a display 24, a data processor 21, a storage 26, a communicator 22, and a bus 27. The acceptor 25, display controller 23, display 24, data processor 21, storage 26, and communicator 22 can communicate with each other via the bus 27.

A part or all of the acceptor 25, display controller 23, data processor 21, and communicator 22 is a software function unit which functions by, for example, execution of a program stored in the storage 26 by a processor such as a CPU. Moreover, a part or all of these function units may be a hardware function unit such as an LSI or ASIC.

The data processor 21 generates an image for authentication of the worker and outputs the generated image to the display controller 23. The data processor 21 also generates an image corresponding to a signal acquired from the acceptor 25 and outputs the generated image to the display controller 23. The signal acquired from the acceptor 25 corresponds to, for example, operation by the worker.

The communicator 22 transmits, to the reuse support device 10, the authentication operation information representing authentication operation of input of the worker number or the like accepted by the acceptor 25. The communicator 22 transmits, to the management device 30 (manager), information of the reuse mode of the power facility selected by the selection operation key image (hereinafter referred to as “reuse mode information”). The communicator 22 receives an image from the reuse support device 10 and transfers the received image to the display controller 23.

The display controller 23 displays an image on the display 24 using, for example, a web browser. This image may be, for example, an image generated by the data processor 12 or the image acquired via the communicator 22. The image generated by the data processor 12 may be, for example, an image for authentication of the worker. Also, the image acquired via the communicator 22 may be, for example, an image including both of the selection operation key image and boundary sample image or an image not including the specific selection operation key image but including the boundary sample image.

The display 24 displays the image on a display screen in response to control by the display controller 23. The display 24 may further include a touch panel. The display 24 outputs, to the acceptor 25, a signal corresponding to operation of this touch panel.

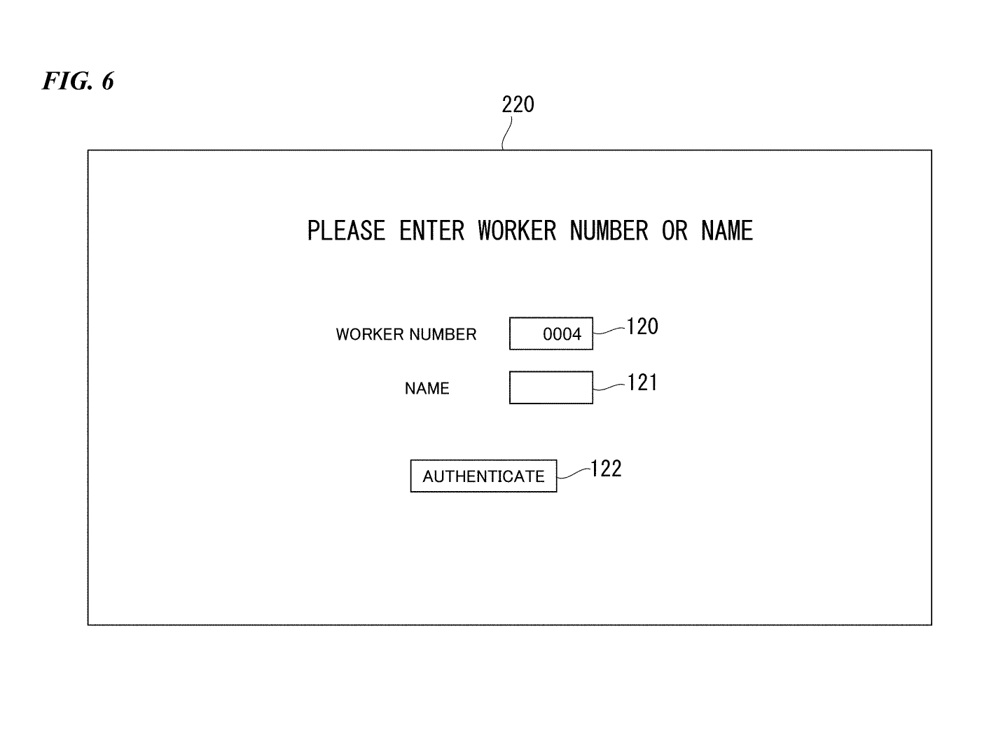

FIG. 6 is a diagram representing an image 220 for authentication of a worker. The image 220 includes a worker number input area 120, a name input area 121, and an authentication operation key image 122. The worker number input area 120 is an area for inputting a worker number. The name input area 121 is an area for inputting a name of a worker associated with the worker number. The authentication operation key image 122 is an image of an operation key operated when the worker number, input to the worker number input area 120, is fixed.

When the authentication operation key image 122 is operated, the acceptor 25 acquires the worker number input to the worker number input area 120 of the image 220 and outputs the authentication operation information including the acquired worker number to the communicator 22. When the authentication operation key image 122 is operated, the acceptor 25 may acquire the worker name input to the name input area 121 of the image 220 and output the authentication operation information including the acquired worker name to the communicator 22.

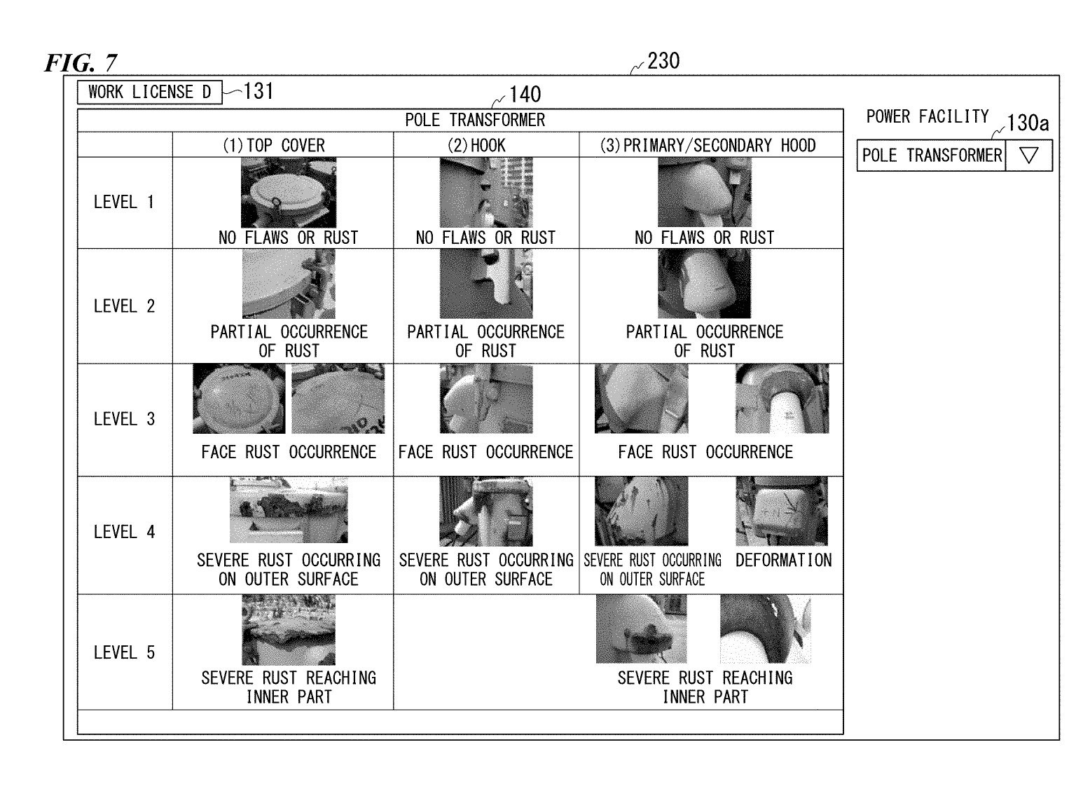

FIG. 7 is a diagram representing an exemplary image 230 including a boundary sample image 140. The display controller 23 acquires, from the communicator 22, the image 230 provided by the provider 17 of the reuse support device 10. The display 24 displays the image 230 in response to control by the display controller 23. The image 230 includes a power facility menu operation key image 130a, a work license display area 131, and a boundary sample image 140.

The power facility menu operation key image 130a is an operation key for selecting a type of the power facility. The acceptor 25 outputs, to the data processor 21, a signal corresponding to operation of the power facility menu operation key image 130a. The work license display area 131 is an area for displaying a work license granted to a worker operating the reuse support terminal 20.

In FIG. 7, the power facility “pole transformer” is selected by operation via the power facility menu operation key image 130a by the worker. In FIG. 7, the worker can select the power facility by operating the power facility menu operation key image 130a in the form of a pulldown menu.

The boundary sample image 140 is a boundary sample image of the power facility “pole transformer” selected by the power facility menu operation key image 130a. The boundary sample image 140 is assumed as a reference for reuse of the pole transformer and used for judgement of the reuse mode of the pole transformer by the worker based at least in part on a state of the pole transformer.

In FIG. 7, the boundary sample image 140 includes images for each level of the state of the pole transformer as the power facility. The levels of the state of the pole transformer represent degrees of flaws or rust occurrence of the pole transformer or degrees of deformation of the pole transformer. As the state of the pole transformer, for example, five levels from level 1 to level 5 are defined. The level 1 is a level of a state of a power facility where reuse without repair is appropriate. The level 5 is a level of a state of a power facility where discarding is appropriate.

Hereinafter, a power facility in a state judged as the level 1 is judged as the reuse mode “good”. A power facility in a state judged as the level 2 is judged as the reuse mode “minor repair”. A power facility in a state judged as the level 3 is judged as the reuse mode “acceptable (e.g. re-paint entirely)”. A power facility in a state judged as the level 4 is judged as the reuse mode “acceptable (e.g. replacement of outer case)”. A power facility in a state judged as the level 5 is judged as the reuse mode “useless”.

In FIG. 7, the boundary sample image 140 includes an image of a pole transformer in a state judged as the level 1, an image of a pole transformer in a state judged as the level 2, an image of a pole transformer in a state judged as the level 3, an image of a pole transformer in a state judged as the level 4, and an image of a pole transformer in a state judged as the level 5. The boundary sample image 140 may further include images for each part of the pole transformer.

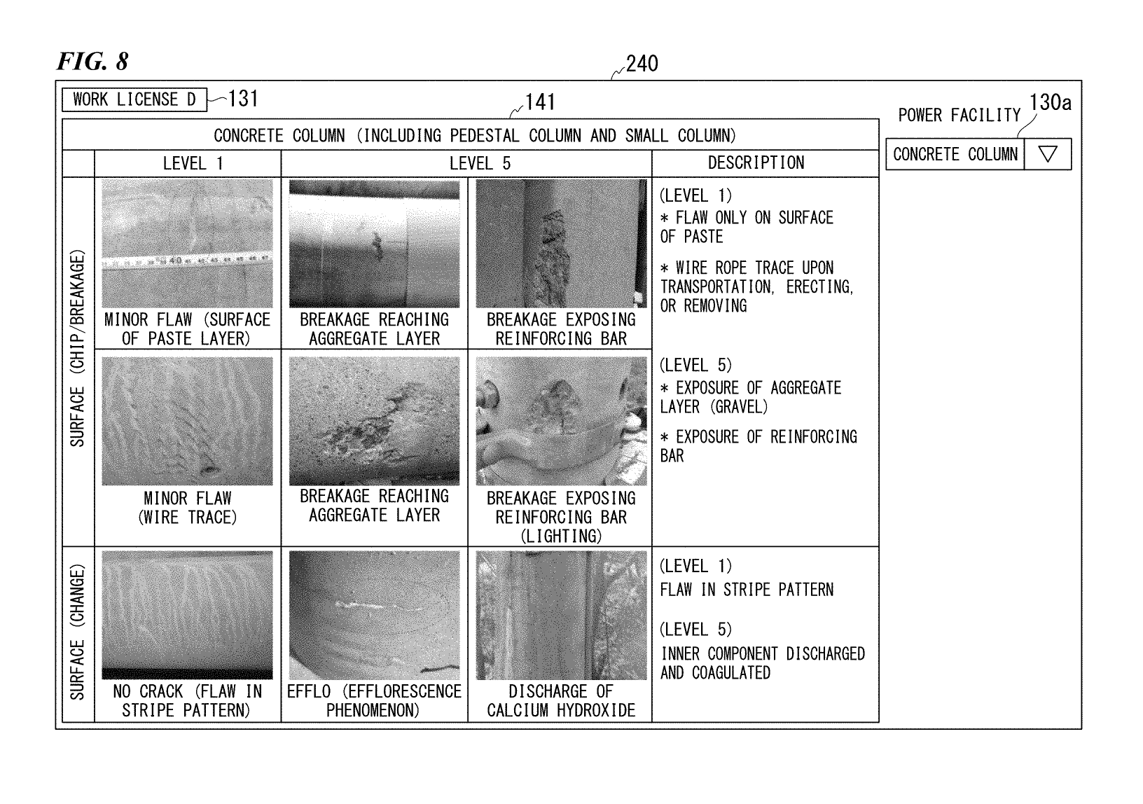

FIG. 8 is a diagram representing an exemplary image 240 including a boundary sample image 141. The display controller 23 acquires, from the communicator 22, the image 240 provided by the provider 17 of the reuse support device 10. The display 24 displays the image 240 in response to control by the display controller 23. The image 240 includes the power facility menu operation key image 130a, the work license display area 131, and a boundary sample image 141.

In FIG. 8, a power facility “concrete column” is selected by operation via the power facility menu operation key image 130a by the worker. The worker can change a power facility to be selected from this selection state to “pole transformer” by operating the power facility menu operation key image 130a in the form of a pulldown menu.

The boundary sample image 141 is a boundary sample image of the power facility “concrete column” selected by the power facility menu operation key image 130a. The boundary sample image 141 is assumed as a reference for reuse of the concrete column and used for judgement of the reuse mode of the concrete column by the worker based at least in part on a state of the concrete column.

In FIG. 8, the boundary sample image 141 includes images for each level of the state of the concrete column as the power facility. The levels of the state of the concrete column represent degrees of flaws or breakage occurrence of the concrete column or degrees of exposure of a reinforcing bar of the concrete column. As the state of the concrete column, for example, two levels of level 1 and level 5 are defined while intermediate levels (from level 2 to level 4) are skipped. Incidentally, similarly to the pole transformer intermediate levels (from level 2 to level 4) may also be defined for the state of the concrete column.

In FIG. 8, the boundary sample image 141 includes an image of a concrete column in a state judged as the reuse mode “level 1” and an image of a concrete column in a state judged as the reuse mode “level 5”. The boundary sample image 141 may further include images for each state of a surface of the concrete column. The boundary sample image 141 may also include letters representing a description for supporting judgement of the reuse mode.

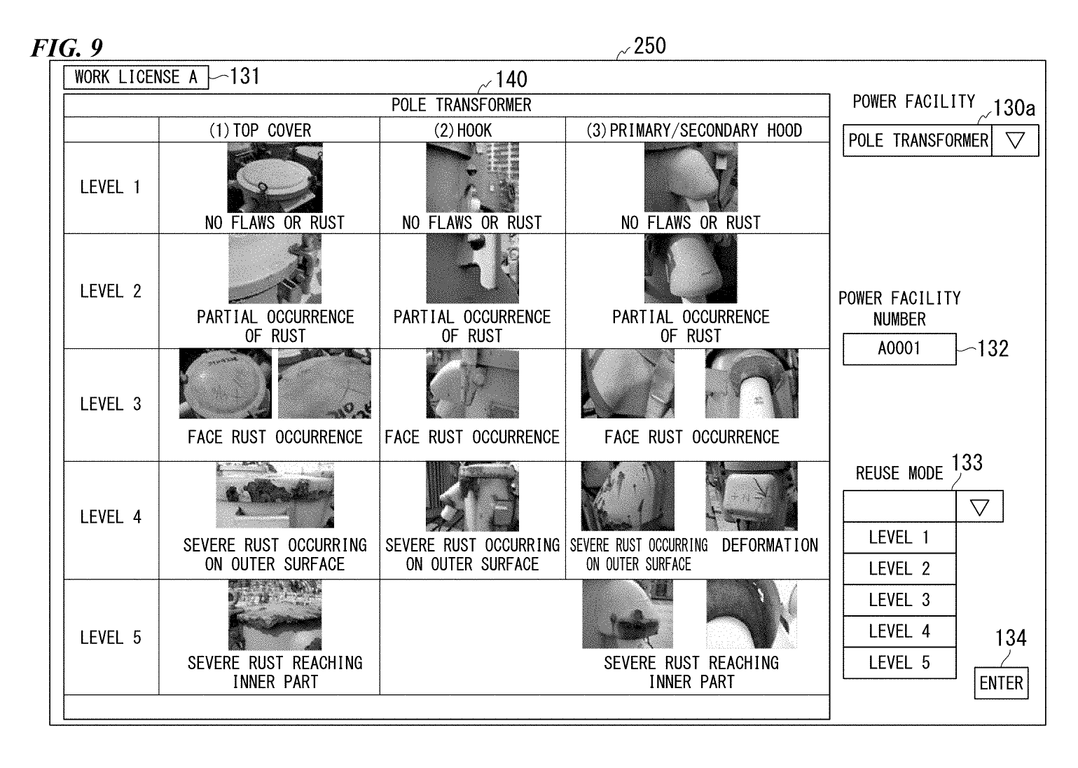

FIG. 9 is a diagram representing an exemplary image 250 including the boundary sample image 140. Only different points between FIG. 7 and FIG. 9 will be described. The display controller 23 acquires, from the communicator 22, an image 250 provided by the provider 17 of the reuse support device 10. The display 24 displays the image 250 in response to control by the display controller 23.

In FIG. 9, the work license display area 131 displays the work license “work license A” granted to the worker based at least in part on the authentication operation information. The worker granted with the work license A can select the reuse mode of a power facility. Therefore, the image 250 further includes, as compared to the image 230 represented in FIG. 7, a power facility number area 132, a selection operation key image 133, and a determination operation key image 134.

The power facility number area 132 is an area for a worker to input a power facility number. The power facility number may be included in the reuse mode information of the power facility selected by the selection operation key image 133.

The selection operation key image 133 is displayed in an operable manner, for example, in the form of a pulldown menu. In FIG. 9, the worker can select one of levels 1 to 5 as a state of the power facility “pole transformer” by operating the selection operation key image 133. That is, the worker can select one of the reuse modes “good”, “minor repair”, “acceptable”, and “useless” for the power facility “pole transformer” by operating the selection operation key image 133.

The determination operation key image 134 is an image of an operation key operated when the input reuse mode is fixed.

The acceptor 25 accepts selection of the reuse mode of the power facility via the selection operation key image 133 included in the image 250 which the display controller 23 has acquired from the communicator 22.

The acceptor 25 accepts selection as to whether the reuse mode is “good” as selection of the reuse mode of the power facility via the selection operation key image 133. The acceptor 25 may also accept selection as to whether the facility is reusable, namely, selection as to whether the reuse mode is “useless”, as selection of the reuse mode of the power facility via the selection operation key image 133.

The acceptor 25 may also accept selection whether to reuse the facility with repair, namely, selection as to whether the reuse mode is either “minor repair” or “acceptable”, as selection of the reuse mode of the power facility via the selection operation key image 133. The acceptor 25 may also accept selection on either “minor repair” or “acceptable” representing a judgement result on a degree of repair as selection of the reuse mode of the power facility via the selection operation key image 133.

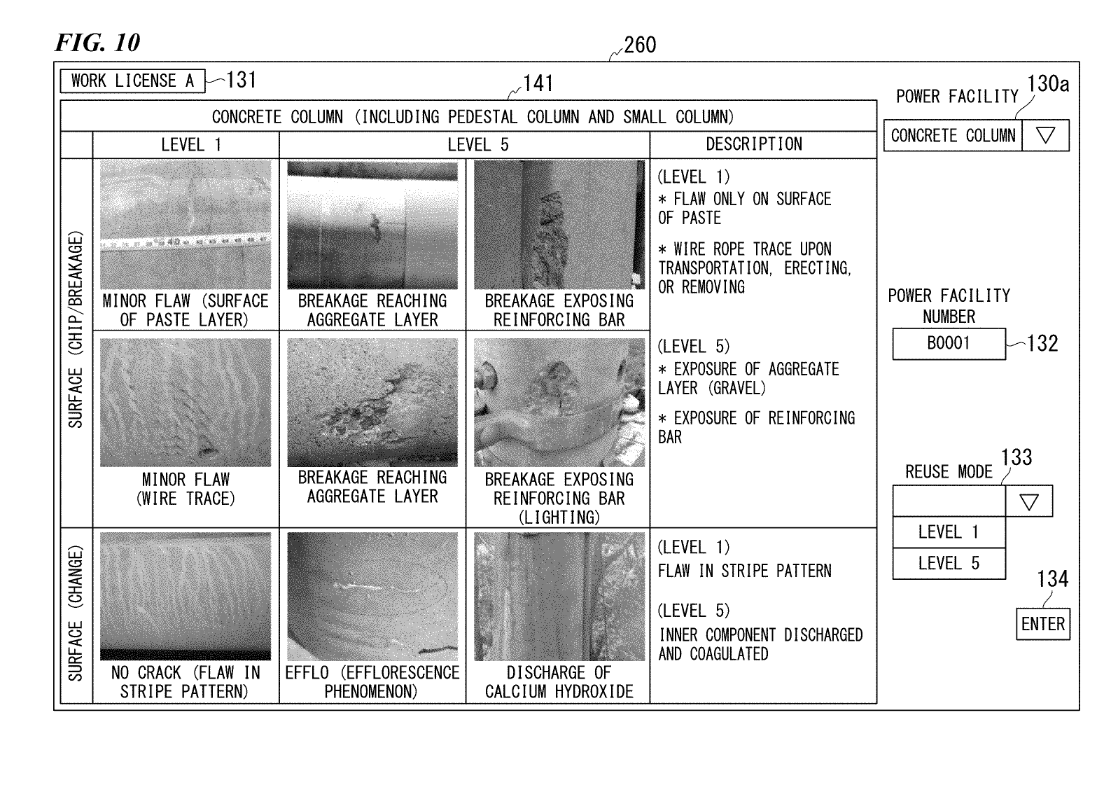

FIG. 10 is a diagram representing an exemplary image 260 including the boundary sample image 141. Only different points between FIG. 10 and FIGS. 8 and 9 will be described. The display controller 23 acquires, from the communicator 22, the image 260 provided by the provider 17 of the reuse support device 10. The display 24 displays the image 260 in response to control by the display controller 23.

In FIG. 10, the work license display area 131 displays the work license “work license A” granted to the worker. Therefore, the image 260 further includes, as compared to the image 240 represented in FIG. 8, the power facility number area 132, the selection operation key image 133, and the determination operation key image 134.

In FIG. 10, the worker can select level 1 or level 5 as a state of the power facility “concrete column” by operating the selection operation key image 133. That is, the worker can select the reuse mode “good” “useless” for the power facility “concrete column” by operating the selection operation key image 133.

The storage 26 includes a nonvolatile storage medium (non-temporal storage medium) such as a ROM, flash memory, or HDD. The storage 26 may include a volatile storage medium such as a RAM or register. The storage 26 may store a program for causing the software function unit to operate.

The storage 26 may store, for each of workers, the authentication operation information accepted by the acceptor 25. The storage 26 may store, for each of power facilities, the reuse mode information of the power facility selected by the selection operation key image 133.

A configuration of the management device 30 will be described.

The management device 30 receives the reuse mode information of the power facility from the communicator 22 of the reuse support terminal 20. The management device 30 manages a delivery destination of the power facility based at least in part on the reuse mode of the power facility selected by the acceptor 25 of the reuse support terminal 20. The management device 30 delivers the power facility to a delivery destination based at least in part on the reuse mode information using a vehicle or the like. The delivery destination based at least in part on the reuse mode information includes, for example, a facility to which a technician specialized in power facility repair belongs, a facility of a manufacturer of power facilities, or a facility for discarding power facilities.

Operations of the reuse support system 1 will be described.

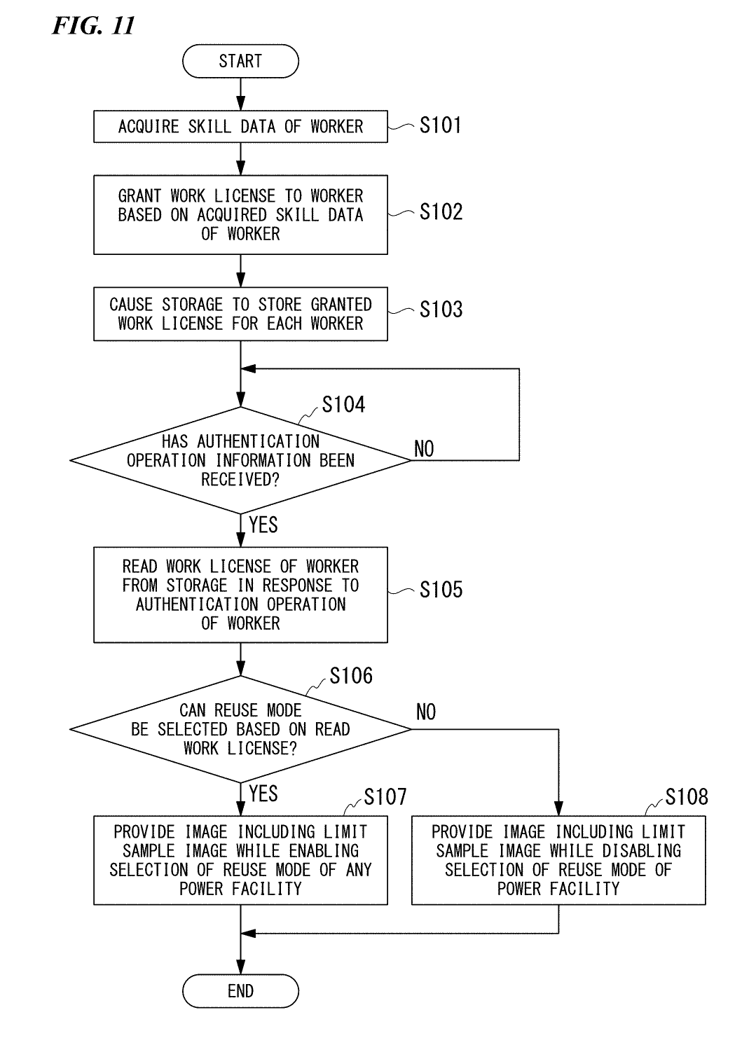

FIG. 11 is a flowchart representing operations of the reuse support device 10.

The acquisitor 11 acquires skill data of workers (step S101).

Next, the grantor 14 grants a work license to the workers based at least in part on the acquired skill data of the workers (step S102).

Next, the grantor 14 stores the granted work license for each of the workers in the storage 13 (step S103).

Next, the grantor 14 determines whether authentication operation information has been received by the communicator 18 (step S104). When the authentication operation information has not been received by the communicator 18 (step S104: NO), the grantor 14 repeats the processing of step S104.

Next, when the authentication operation information has been received by the communicator 18 (step S104: YES), the provider 17 reads the work license of the worker from the storage 13 based at least in part on the authentication operation information corresponding to authentication operation of the worker (step S105).

Next, the provider 17 determines whether the reuse mode (good, minor repair, acceptable, useless) can be selected with the read work license (step S106).

Next, when the reuse mode can be selected (step S106: YES), the provider 17 provides the images 250 and 260 to the reuse support terminal 20 via the communicator 18 while enabling selection of the reuse mode of any power facility. The images 250 and 260 include the power facility menu operation key image 130a, work license display area 131, power facility number area 132, selection operation key image 133, determination operation key image 134, and boundary sample image 140 (step S107). The reuse support device 10 then ends the processing represented in FIG. 11.

Next, when the reuse mode cannot be selected (step S106: NO), the provider 17 provides the image 230 or 240 to the reuse support terminal 20 via the communicator 18 while disabling selection of the reuse mode of the power facility. The images 230 and 240 do not include the selection operation key image 133 but include the power facility menu operation key image 130a, work license display area 131, and boundary sample image 140 (step S108). The reuse support device 10 then ends the processing represented in FIG. 11.

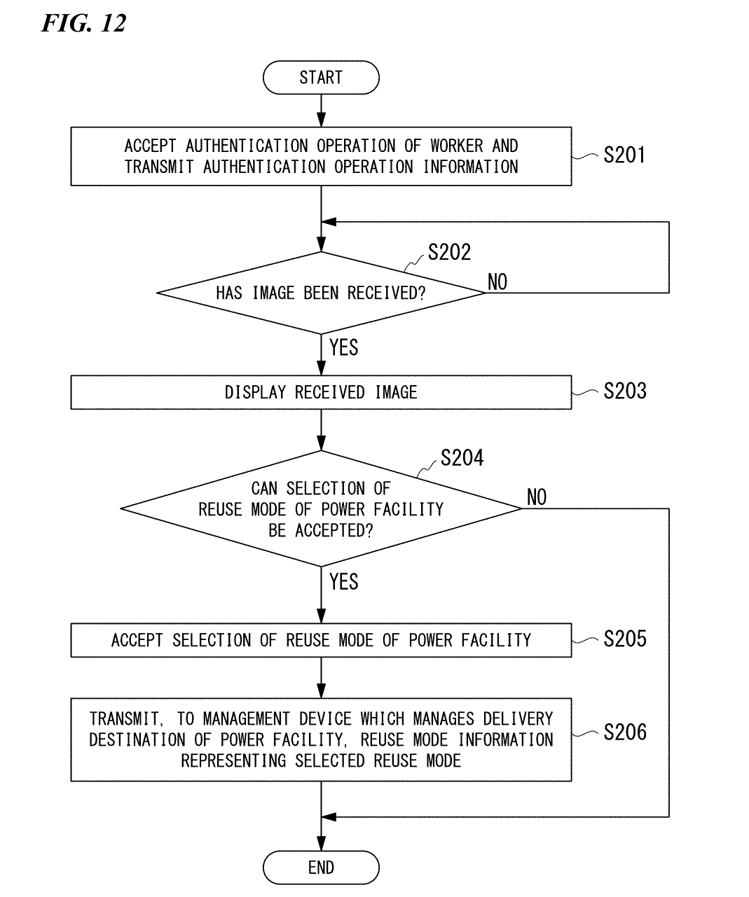

FIG. 12 is a flowchart representing operations of the reuse support terminal 20.

The acceptor 25 accepts authentication operation of the worker and transmits the authentication operation information to the reuse support device 10 via the communicator 22 (step S201).

Next, the display controller 23 determines whether the communicator 22 has received an image from the reuse support device 10 (step S202). When the communicator 22 has not received an image from the reuse support device 10 (step S202: NO), the display controller 23 repeats the processing of step S202.

Next, when the communicator 22 has received an image from the reuse support device 10 (step S202: NO), the display controller 23 displays the received image on the display 24 (step S203).

Next, the acceptor 25 determines whether selection of the reuse mode of a power facility can be accepted based at least in part on whether the image received via the communicator 22 includes the selection operation key image 133 (step S204). When selection of the reuse mode of the power facility cannot be accepted (step S204: NO), the reuse support terminal 20 ends the processing represented in FIG. 12.

Next, when selection of the reuse mode of the power facility can be accepted (step S204: YES), the acceptor 25 accepts selection of the reuse mode of the power facility in response to operation via the selection operation key image 133 (step S205).

Next, the acceptor 25 transmits, to the management device 30 via the communicator 22, the reuse mode information representing the selected reuse mode (step S206). The reuse support terminal 20 then ends the processing represented in FIG. 12.

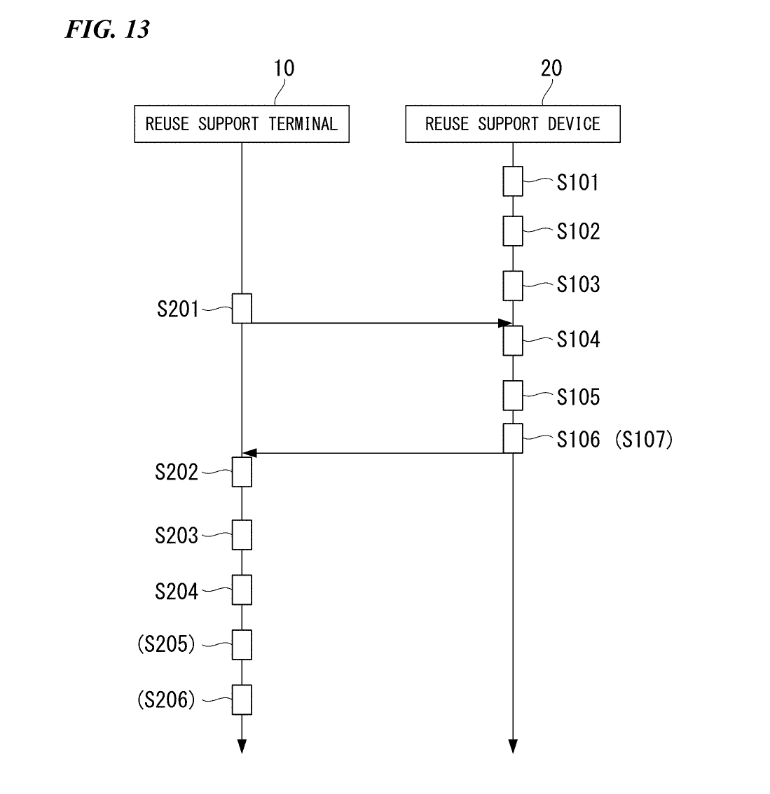

FIG. 13 is a sequence diagram representing operations of the reuse support system 1.

Processing of steps S101 to S107 represented in FIG. 13 is equivalent to the aforementioned processing of steps S101 to S107 represented in FIG. 11. Also, processing of steps S201 to S206 represented in FIG. 13 is equivalent to the aforementioned processing of steps S201 to S206 represented in FIG. 11.

For example, in step S104, the reuse support device 10 receives authentication operation information from the reuse support terminal 20 which has executed step S201. Also, in step S202 for example, the reuse support terminal 20 receives the images 250 and 260 from the reuse support terminal 20 which has executed step S106 or S107.

As described above, the reuse support system 1 of the first embodiment includes the acquisitor 11 which acquires skill data of workers, the grantor 14 which grants a work license to the workers based at least in part on the acquired skill data of the workers and stores the granted work license for each of the workers in the storage 13, and the provider 17 which reads the work license from the storage 13 in response to authentication operation of the workers and provides an image including the selection operation key image 133 in accordance with the read work license.

With this configuration, the provider 17 reads the work license from the storage 13 in response to authentication operation of the worker and provides an image including the selection operation key image 133 in accordance with the read work license. As a result, the reuse support system 1 of the first embodiment allows a worker to judge the reuse mode of the facility in an appropriate and efficient manner. Moreover, the reuse support system 1 of the first embodiment allows for preventing a worker without skills from judging the reuse mode of the facility. Furthermore, the reuse support system 1 of the first embodiment allows for supporting judgement on the reuse mode of the facility. Also, the reuse support system 1 of the first embodiment allows for suppressing cost for purchasing new facilities.

The reuse support system 1 of the first embodiment includes the acceptor 25 which accepts selection of the reuse mode of the facility when selection of the reuse mode of the facility can be accepted in accordance with an image including the selection operation key image 133 provided by the provider 17.

With this configuration, when selection of the reuse mode of the facility can be accepted in accordance with the provided image, the acceptor 25 accepts selection of the reuse mode of the facility. As a result, the reuse support system 1 of the first embodiment allows for supporting judgement on the reuse mode of the facility. Also, the reuse support system 1 of the first embodiment allows for suppressing cost for purchasing new facilities.

The reuse support device 10 of the first embodiment includes the acquisitor 11 which acquires skill data of workers, the grantor 14 which grants a work license to the workers based at least in part on the acquired skill data of the workers and stores the granted work license for each of the workers in the storage 13, and the provider 17 which reads the work license from the storage 13 in response to authentication operation of the workers and provides an image in accordance with the read work license.

With this configuration, the provider 17 reads the work license from the storage 13 in response to authentication operation of the worker and provides an image in accordance with the read work license. As a result, the reuse support device 10 of the first embodiment allows a worker to judge the reuse mode of the facility in an appropriate and efficient manner. Moreover, the reuse support device 10 of the first embodiment allows for preventing a worker without skills from judging the reuse mode of the facility. Furthermore, the reuse support device 10 of the first embodiment allows for supporting judgement on the reuse mode of the facility.

The reuse support system 1 of the first embodiment includes the display controller 23 which displays, on the display 24, an image including an image ora boundary sample which serves as a reference for reuse of the facility in response to operation of a worker, the acceptor 25 which accepts selection of the reuse mode of the facility, and the management device 30 which manages a delivery destination of the facility based at least in part on the reuse mode of the facility selected by the acceptor 25.

As a result, the reuse support system 1 of the first embodiment allows for supporting judgement on the reuse mode of the facility. Also, the reuse support system 1 of the first embodiment allows for suppressing cost for purchasing new facilities.

The reuse support terminal 20 of the first embodiment includes the display controller 23 which displays, on the display 24, an image including an image of a boundary sample which serves as a reference for reuse of the facility in response to operation of a worker, the acceptor 25 which accepts selection of the reuse mode of the facility, and the communicator 22 which transmits reuse mode information for specifying a delivery destination to the management device 30 which manages the delivery destination of the facility in accordance with selection of the reuse mode of the facility having been accepted by the acceptor 25.

As a result, the reuse support terminal 20 of the first embodiment allows for supporting judgement on the reuse mode of a facility. Also, the reuse support terminal 20 of the first embodiment allows for suppressing cost for purchasing new facilities.

### Second Embodiment

Hereinafter, a second embodiment will be described. In the first embodiment, a worker granted with a work license of a certain level or above (work license C or above) can select the reuse mode for any of the predetermined power facilities. Contrary to this, in the second embodiment, it is different from the first embodiment that a worker can select the reuse mode only for the power facility which is associated with the granted work license is different. In the second embodiment, only different points from the first embodiment will be described.

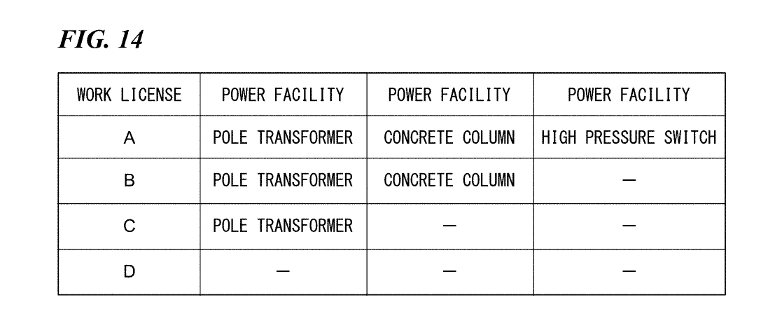

FIG. 14 is a diagram representing a data table including information of a work license and the power facility the reuse mode of which is selectable. This data table is stored in the storage 13 of the reuse support device 10. In the second embodiment, the work license includes information of one of levels A to D as information for determining, for each of power facilities, whether to accept selection of the reuse mode of the power facility.

In FIG. 14, work license A is associated with, for example, a pole transformer, concrete column, and high pressure switch. Work license B is associated with, for example, a pole transformer and concrete column. Work license C is associated with, for example, a pole transformer. Work license D is not associated with any of the power facilities.

The provider 17 determines that selection of the reuse mode of the power facility can be accepted when the work license read from the table data represented in FIG. 4 is one of A to C. The provider 17 provides, to the reuse support terminal 20, an image including a power facility menu operation key image 130b corresponding to the work license when selection of the reuse mode of the power facility can be accepted.

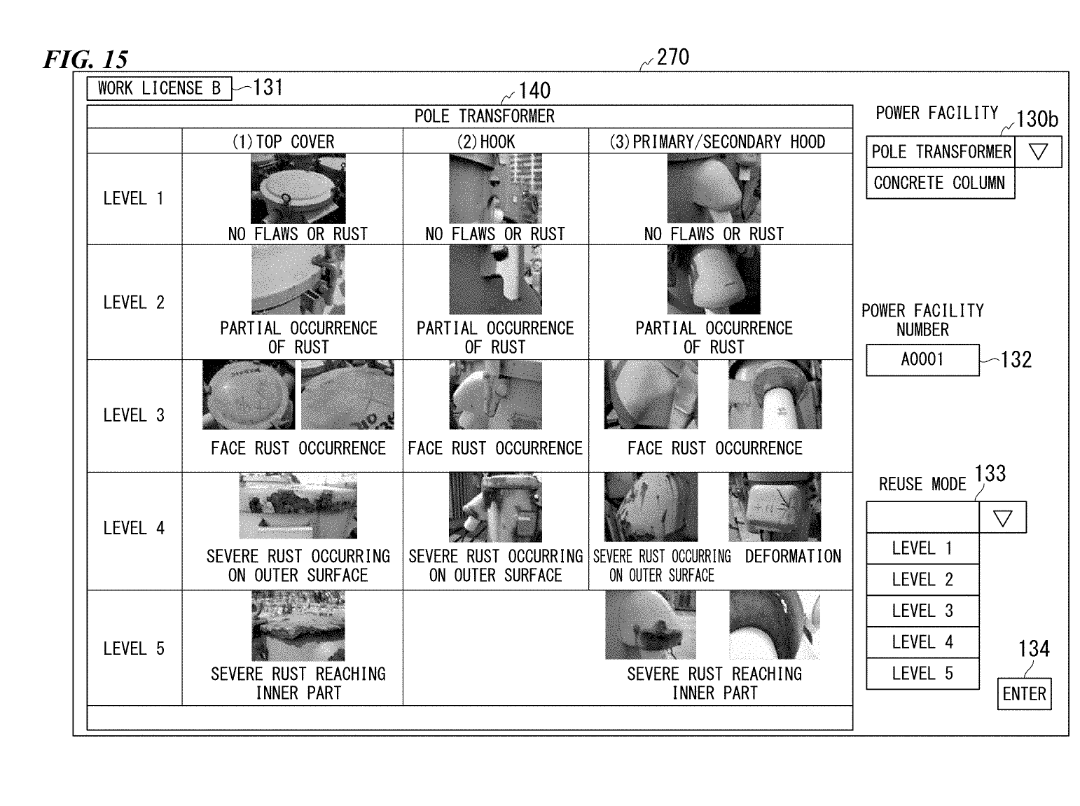

FIG. 15 is a diagram representing an exemplary image 270 including the boundary sample image 140. Only different points between FIG. 9 and FIG. 15 will be described. The display controller 23 acquires, from the communicator 22, the image 270 provided by the provider 17 of the reuse support device 10. The display 24 displays the image 270 in response to control by the display controller 23.

In FIG. 15, the work license display area 131 displays the work license “work license B” granted to a worker based at least in part on authentication operation information. The worker granted with the work license B can select the reuse mode of the power facilities “pole transformer” and “concrete column” as represented in FIG. 14. Therefore, different from the image 250 represented in FIG. 9, the image 270 includes the power facility menu operation key image 130b associated with the granted work license B in place of the power facility menu operation key image 130a.

The power facility menu operation key image 130b displays, in the form of a pulldown menu, the power facilities “pole transformer” and “concrete column” associated with the work license B. This allows the worker to select the reuse mode for each of the power facilities “pole transformer” and “concrete column” respectively.

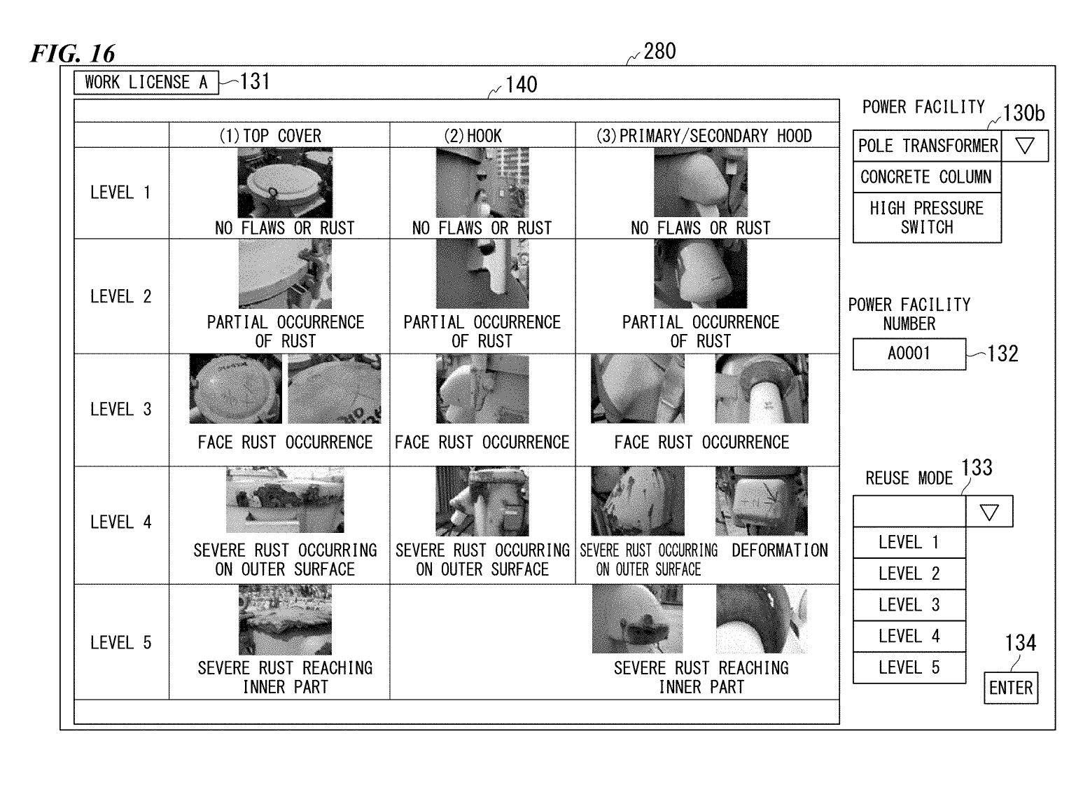

FIG. 16 is a diagram representing an exemplary image 280 including the boundary sample image 140. Only different points between FIG. 15 and FIG. 16 will be described. The display controller 23 acquires, from the communicator 22, the image 280 provided by the provider 17 of the reuse support device 10. The display 24 displays the image 280 in response to control by the display controller 23.

In FIG. 16, the work license display area 131 displays the work license “work license A” granted to the worker based at least in part on the authentication operation information. The worker granted with the work license A can select the reuse mode of the power facilities “pole transformer”, “concrete column”, and “high pressure switch” as represented in FIG. 14. Therefore, different from the image 270 represented in FIG. 15, the image 280 includes the power facility menu operation key image 130b associated with the granted work license A.

The power facility menu operation key image 130b displays, in the form of a pulldown menu, the power facilities “pole transformer”, “concrete column”, and “high pressure switch” associated with the work license A. This allows the worker to select the reuse mode for each of the power facilities “pole transformer”, “concrete column”, and “high pressure switch”.

Operations of the reuse support system 1 will be described.

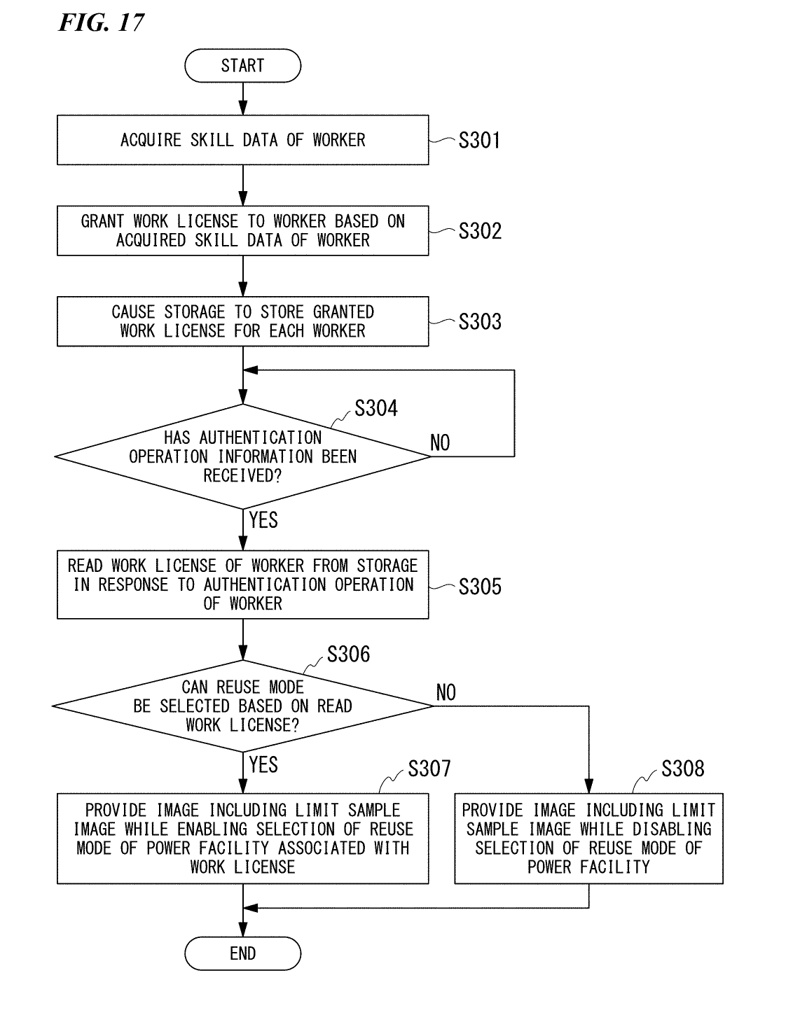

FIG. 17 is a flowchart representing operations of the reuse support device 10. Processing of steps S301 to S306 represented in FIG. 17 is similar to the aforementioned processing of steps S101 to S106 represented in FIG. 11. Also, processing of step S308 represented in FIG. 17 is similar to the aforementioned processing of step S108 represented in FIG. 11.

When the reuse mode can be selected (step S306: YES), the provider 17 provides the images 250 and 260 to the reuse support terminal 20 via the communicator 18 while enabling selection of the reuse mode of the power facility associated with the work license (step S307). The reuse support device 10 then ends the processing represented in FIG. 17.

In this manner, as represented in FIG. 14, the work license includes information of one of levels A to D as information for determining, for each of the power facilities, whether to accept selection of the reuse mode of the power facility. When selection of the reuse mode of the power facility can be accepted, the provider 17 provides the images 250 and 260 including the power facility menu operation key image 130b which can accept, for each of the power facilities, selection of the reuse mode of the power facility.

As a result, the reuse support system 1 of the second embodiment allows for defining, for each of the work licenses, the power facility the reuse mode of which can be selected.

Embodiments of this invention has been described above in detail with reference to drawings. However, a specific configuration is not limited to these embodiments and may include designs within a range not departing from the principals of the invention.

For example, the display controller 23 of the reuse support terminal 20 may display the image provided by the provider 17 on the display 24 without using a web browser. In this case, the display controller 23 may generate the image provided by the provider 17 in place of the provider 17 by, for example, executing application software stored in the storage 26. The display controller 23 may display the image generated in place of the provider 17 on the display 24.

The apparatus, systems and methods in the above-described embodiments may be deployed in part or in whole through machines, a system of circuits, circuitry, hardware processors that executes computer software, software components, program codes, and/or instructions on one or more machines, a system of circuits, circuitry, hardware processors. In some cases, the one or more machines, a system of circuits, circuitry, hardware processors may be part of a general-purpose computer, a server, a cloud server, a client, network infrastructure, mobile computing platform, stationary computing platform, or other computing platform. One or more processors may be any kind of computational or processing device or devices which are capable of executing program instructions, codes, binary instructions and the like. The one or more hardware processors may be or include a signal processor, digital processor, embedded processor, microprocessor or any variants such as a co-processor, for example, math co-processor, graphic co-processor, communication co-processor and the like that may directly or indirectly facilitate execution of program codes or program instructions stored thereon. In addition, the one or more hardware processors may enable execution of multiple programs, threads, and codes. The threads may be executed simultaneously to enhance the performance of the one or more hardware processors and to facilitate simultaneous operations of the application. Program codes, program instructions and the like described herein may be implemented in one or more threads. The one or more hardware processors may include memory that stores codes, instructions and programs as described herein. The machines, a system of circuits, circuitry, hardware processors may access a non-transitory processor-readable storage medium through an interface that may store codes, instructions and programs as described herein and elsewhere. The non-transitory processor-readable storage medium associated with the machines, a system of circuits, circuitry, hardware processors for storing programs, codes, program instructions or other type of instructions capable of being executed by the computing or processing device may include but may not be limited to one or more of a memory, hard disk, flash drive, RAM, ROM, CD-ROM, DVD, cache and the like.

A processor may include one or more cores that may enhance speed and performance of a multiprocessor. In some embodiments, the process may be a dual core processor, quad core processors, other chip-level multiprocessor and the like that combine two or more independent cores.

The methods, apparatus and systems described herein may be deployed in part or in whole through a machine that executes computer software on a server, client, firewall, gateway, hub, router, or other such computer and/or networking hardware.

The software program may be associated with one or more client that may include a file client, print client, domain client, internet client, intranet client and other variants such as secondary client, host client, distributed client and the like. The client may include one or more of memories, processors, computer readable media, storage media, physical and virtual ports, communication devices, and interfaces capable of accessing other clients, servers, machines, and devices through a wired or a wireless medium; and the like. The programs or codes as described herein may be executed by the client. In addition, other devices required for execution of methods as described in this application may be considered as a part of the infrastructure associated with the client. The client may provide an interface to other devices including servers, other clients, printers, database servers, print servers, file servers, communication servers, distributed servers and the like. This coupling and/or connection may facilitate remote execution of program across the network. The networking of some or all of these devices may facilitate parallel processing of a program or method at one or more location. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The software program may be associated with one or more servers that may include a file server, print server, domain server, internet server, intranet server and other variants such as secondary server, host server, distributed server and the like. The server may include one or more of memories, processors, computer readable media, storage media, physical and virtual ports, communication devices, and interfaces capable of accessing other servers, clients, machines, and devices through a wired or a wireless medium, and the like. The methods, programs or codes as described herein may be executed by the server. In addition, other devices required for execution of methods as described in this application may be considered as a part of the infrastructure associated with the server. The server may provide an interface to other devices including clients, other servers, printers, database servers, print servers, file servers, communication servers, distributed servers, social networks, and the like. This coupling and/or connection may facilitate remote execution of program across the network. The networking of some or all of these devices may facilitate parallel processing of a program or method at one or more locations. Any of the devices attached to the server through an interface may include at least one storage medium capable of storing programs, codes and/or instructions. A central repository′ may provide program instructions to be executed on different devices. In this implementation, the remote repository may act as a storage medium for program codes, instructions, and programs.

The methods, apparatus and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing devices associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory, for example, USB sticks or keys, floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The modules, engines, components, and elements described herein, including in flow charts and block diagrams throughout the figures, imply logical boundaries between the modules, engines, components, and elements. However, according to software or hardware engineering practices, the modules, engines, components, and elements and the functions thereof may be implemented on one or more processors, computers, machines through computer executable media, which are capable of executing program instructions stored thereon as a monolithic software structure, as standalone software modules, or as modules that employ external routines, codes, services, or any combination of these, and all such implementations may be within the scope of the present disclosure. Examples of such machines may include, but is not limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers, processor-embedded eyewear and the like. Furthermore, the modules, engines, components, and elements in the flow chart and block diagrams or any other logical component may be implemented on one or more machines, computers or processors capable of executing program instructions. Whereas the foregoing descriptions and drawings to which the descriptions have been referred set forth some functional aspects of the disclosed systems, no particular arrangement of software for implementing these functional aspects should be inferred from these descriptions unless explicitly stated or otherwise clear from the context. It will also be appreciated that the various steps identified and described above may be varied, and that the order of steps may be adapted to particular applications of the techniques disclosed herein. All such variations and modifications are intended to fall within the scope of this disclosure. The descriptions of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

As used herein, the following directional terms “front, back, above, downward, right, left, vertical, horizontal, below, transverse, row and column” as well as any other similar directional terms refer to those instructions of a device equipped with embodiments of the present invention. Accordingly, these terms, as utilized to describe embodiments of the present invention should be interpreted relative to a device equipped with embodiments of the present invention.

Each element for the system, device and apparatus described above can be implemented by hardware with or without software. In some cases, the system, device and apparatus may be implemented by one or more hardware processors and one or more software components wherein the one or more software components are to be executed by the one or more hardware processors to implement each element for the system, device and apparatus. In some other cases, the system, device and apparatus may be implemented by a system of circuits or circuitry configured to perform each operation of each element for the system, device and apparatus.

While the present disclosure includes many embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

What is claimed is:

1. A reuse support system, comprising:
a display controller configured to make a display device display an image including at least a boundary sample image illustrative of a boundary sample which serves as a reference for reuse of a power facility in response to operation of a worker;
an acceptor configured to accept a selection of a reuse mode of the power facility; and
a manager configured to manage a delivery destination of the power facility based at least in part on the reuse mode of the power facility selected by the acceptor,
wherein the boundary sample image includes an image of each part of the power facility, and
wherein the display controller is configured to provide an image including the boundary samples image arranged for each level of a flaw or deformation of the power facility, the display controller is configured to cause the display device to display an image including an accepting image allowing a user to accept the selection of the reuse mode of the power facility in accordance with the level of a flaw or deformation of the power facility.

2. The reuse support system according to claim 1,
wherein the acceptor is configured to accept a selection as to whether the power facility is reusable as the selection of the reuse mode of the power facility.

3. The reuse support system according to claim 1,
wherein the acceptor is configured to accept a selection whether to repair and reuse the power facility as the selection of the reuse mode of the power facility.

4. The reuse support system according to claim 3,
wherein the acceptor is configured to accept a selection representing a judgement result of a level of the repair as the selection of the reuse mode of the power facility.

5. The reuse support system according to claim 1, further comprising:
a communicator is configured to transmit, to the manager, information for specifying the delivery destination.

6. A reuse support method, comprising:
making a display device display an image including at least a boundary sample image illustrative of a boundary sample which serves as a reference for reuse of a power facility in response to operation of a worker;
accepting a selection of a reuse mode of the power facility; and
managing a delivery destination of the power facility based at least in part on the reuse mode of the power facility selected,
wherein the boundary sample image includes an image of each part of the power facility, and
wherein making the display device display the image comprises:
providing an image including the boundary samples image arranged for each level of a flaw or deformation of the power facility; and
causing the display device to display an image including an accepting image allowing a user to accept the selection of the reuse mode of the power facility in accordance with the level of a flaw or deformation of the power facility.

7. The reuse support method according to claim 1,
wherein accepting the selection comprises:
accepting a selection as to whether the power facility is reusable as the selection of the reuse mode of the power facility.

8. The reuse support method according to claim 1,
wherein accepting the selection comprises:
accepting a selection whether to repair and reuse the power facility as the selection of the reuse mode of the power facility.

9. The reuse support method according to claim 3,
wherein accepting the selection comprises:
accepting a selection representing a judgement result of a level of the repair as the selection of the reuse mode of the power facility.

10. The reuse support method according to claim 1, further comprising:
transmitting, to the manager, information for specifying the delivery destination.
